(19) United States
(12) Patent Application Publication
(10) Pub. No.: US 2025/0254758 A1
(43) Pub. Date: Aug. 7, 2025

(54) FOREIGN OBJECT REMOVAL APPARATUS FOR PACKAGED ELECTRONIC COMPONENTS, AND ANOMALY CONTROL METHOD THEREOF

(71) Applicant: ABLEPRINT TECHNOLOGY CO., LTD., Hsinchu (TW)

(72) Inventors: Chih-Horng HORNG, Hsinchu (TW); Chun-hua LI, Hsinchu (TW)

(73) Assignee: ABLEPRINT TECHNOLOGY CO., LTD., Hsinchu (TW)

(21) Appl. No.: 19/013,892

(22) Filed: Jan. 8, 2025

(30) Foreign Application Priority Data
Feb. 5, 2024 (TW) 113104371
Oct. 1, 2024 (TW) 113137550

(51) Int. Cl. H05B 1/02; B08B 13/00

(52) U.S. Cl. CPC H05B 1/023; B08B 13/00

(57) ABSTRACT

Provided are a foreign object removal apparatus for a packaged electronic component, and an anomaly control method thereof. The foreign object removal apparatus includes a chamber and a control module configured to control a working temperature and a working pressure of the chamber. The anomaly control method includes: obtaining the working temperature and the working pressure of the chamber; determining whether one of the working temperature and the working pressure of the chamber conforms to a default value; and when one of the working temperature and the working pressure of the chamber does not conform to the default value, starting an emergency handling program by the control module to reduce the working temperature and the working pressure until the packaged electronic component can be transferred to another foreign object removal apparatus.

### CROSS-REFERENCE TO RELATED APPLICATIONS

The application claims priority to Taiwan patent application No. 113104371, filed on Feb. 5, 2024, and No. 113137550, filed on Oct. 1, 2024, the entire contents of which are incorporated herein by reference.

### TECHNICAL FIELD

The present disclosure relates to a foreign object removal apparatus, in particular to a foreign object removal apparatus for removing a foreign object in a packaged electronic component, and an anomaly control method thereof.

### BACKGROUND

In the manufacturing process of electronic component packaging, in order to remove foreign objects (pollutants such as voids, grease, and flux residues), it is necessary to control the temperature and pressure of a chamber of a baking device to remove the foreign objects in a material layer during packaging. However, during operation of the baking device, its temperature or pressure may not be within a set range due to various abnormal situations. As a result, the foreign object removal operation will be interrupted or fail, so that packaged electronic components become defective products, resulting in a waste of packaging resources and costs. Therefore, how to better control the temperature and pressure of the device and rescue the electronic components being processed when an abnormal situation occurs is a topic worthy of further research in this field.

### SUMMARY

In view of this, one objective of the present disclosure is to provide a foreign object removal apparatus capable of performing anomaly control on a temperature and a pressure.

In the present disclosure, the foreign object removal apparatus for a packaged electronic component is configured to remove a foreign object in the packaged electronic component, and includes a chamber, a temperature module, an pressure module, and a control module. The chamber is formed with a cavity space. The temperature module is disposed in the chamber and includes a heater configured to increase a working temperature in the cavity space, a cooler configured to reduce the working temperature in the cavity space, and a temperature detection unit configured to detect the working temperature in the cavity space. The pressure module is disposed in the chamber and includes a pressurizer configured to increase a working pressure in the cavity space, a pressure relief valve configured to reduce the working pressure in the cavity space, and a pressure detection unit configured to detect the working pressure in the cavity space. The control module is connected to the temperature module and the pressure module, and is configured to start, when at least one of the working temperature and the working pressure of the cavity space is in an abnormal state and cannot be restored to a default value, an emergency handling program to control the pressure module to maintain the working pressure of the cavity space above a preset pressure, reduce the working temperature of the cavity space in a fast cooling mode, and reduce the working pressure of the cavity space until the chamber can be opened, to ensure that the packaged electronic component can be transferred to another foreign object removal apparatus.

In some embodiments, the foreign object removal apparatus further includes a standby pressurizer, where the control module can also switch to provide the working pressure by the standby pressurizer when the pressure detection unit detects that the working pressure of the cavity space is in the abnormal state.

In some embodiments, the foreign object removal apparatus further includes a warning module that is connected to the control module and gives a warning when at least one of the working temperature or the working pressure of the cavity space is in the abnormal state.

In some embodiments, the foreign object removal apparatus further includes a human-machine interface connected to the control module, where an input is provided to set default values for the working temperature and the working pressure.

Another objective of the present disclosure is to provide an anomaly control method capable of performing anomaly control on the temperature and the pressure of the aforementioned foreign object removal apparatus.

In the anomaly control method for the foreign object removal apparatus according to the present disclosure, the foreign object removal apparatus is configured to remove a foreign object in a packaged electronic component. The anomaly control method includes: obtaining the working temperature and the working pressure of the chamber; and determining the working temperature and the working pressure by the control module, first quickly reducing the working temperature, maintaining the working pressure of the cavity space above a preset pressure, and then slowly reducing the working pressure of the cavity space to ensure that the packaged electronic component can be transferred to another foreign object removal apparatus.

In some embodiments, the control module starts an emergency handling program to control the working temperature of the chamber to be quickly reduced at a speed of 5° C./min or above.

In some embodiments, when the working temperature does not conform to the default value, before starting the emergency handling program, the control module re-controls a temperature module of the foreign object removal apparatus to act for restoring the working temperature of the chamber to the default value, and if the working temperature of the chamber cannot be restored, the working temperature of the chamber is controlled to be quickly reduced to be in a state where the packaged electronic component can be moved out of the chamber.

In some embodiments, when the working pressure does not conform to the default value, before starting the emergency handling program, the control module re-controls an pressure module of the foreign object removal apparatus to act for restoring the working pressure of the chamber to the default value, and if the working pressure of the chamber cannot be restored, the working temperature of the chamber is controlled to be quickly reduced to a predetermined temperature, the working pressure of the chamber is maintained above a preset pressure, and the working pressure of the cavity space is slowly reduced to ensure that the packaged electronic component can be transferred to another foreign object removal apparatus.

In some embodiments, when the working pressure does not conform to the default value, before starting the emergency handling program, the control module detects whether a standby pressurizer that is capable of making the working pressure conform to the default value exists, and if the standby pressurizer exists, switching is performed to make the standby pressurizer replace a pressurizer of the foreign object removal apparatus to operate for making the working pressure conform to the default value.

In some embodiments, when the control module detects that the standby pressurizer that is capable of making the working pressure conform to the default value does not exist, or the standby pressurizer is incapable of making the working pressure conform to the default value, the control module starts the emergency handling program to control the working temperature of the chamber to be quickly reduced to a predetermined temperature, maintain the working pressure of the chamber above a preset pressure, and slowly reduce the working pressure of the chamber space to ensure that the packaged electronic component can be transferred to another foreign object removal apparatus.

In some embodiments, in the emergency handling program, the control module controls the working temperature to be quickly reduced and then slowly reduces the working pressure of the cavity space, and controls the slowly reduced working pressure to be reduced at a speed of 5 Kg/cm² or below per minute.

In some embodiments, the working temperature of the chamber is controlled to be quickly reduced to a predetermined temperature of not greater than 100° C.

In some embodiments, in the emergency handling program, the control module controls the working temperature to be quickly reduced and then controls the working pressure to be reduced at a speed less than a reduction speed after the foreign object removal apparatus completes the removal of the foreign object in the packaged electronic component.

In some embodiments, in the emergency handling program, 150% of the default pressure is not less than the ratio of a pressure before cooling multiplied by a temperature reached by cooling to a temperature before cooling.

The present disclosure has at least the following effects: according to the foreign object removal apparatus and the anomaly control method thereof, when the packaged electronic component is abnormal in the process of removing the foreign object, the abnormal situation can be quickly eliminated in the most effective way, and when it is confirmed that the abnormal situation cannot be eliminated, the temperature can be quickly reduced, the pressure can be slowly reduced, and taken out the packaged electronic component that has not yet completed the foreign object removal operation, so that the packaged electronic component can be transferred to another foreign object removal apparatus for continued operation, thereby avoiding the damage to the packaged electronic component due to the anomaly of a device, and effectively reducing the cost loss caused by the defect rate.

### BRIEF DESCRIPTION OF DRAWINGS

FIG. 1 is a system block diagram of a foreign object removal apparatus for a packaged electronic component in an embodiment of the present disclosure.

FIG. 2 is a schematic sectional view of a packaged electronic component.

FIG. 3 is an exemplary diagram of a temperature-pressure curve.

FIG. 4 is a flowchart of steps of an anomaly control method for a foreign object removal apparatus in an embodiment of the present disclosure.

FIG. 5 is a flowchart of steps of the anomaly control method in another embodiment.

### NUMERAL REFERENCES

1 chamber
11 cavity space
12 working platform
2 temperature module
21 heater
22 temperature detection unit
23 cooler
3 pressure module
3a standby pressurizer
31 pressurizer
32 pressure relief valve
33 pressure detection unit
4 control module
5 packaged electronic component
51 carrier board
52 chip
53 material layer
6 warning module
7 human-machine interface
100, 101, 102, and 105 step
101a, 101b, 101c, 101d, and 101e sub-step
102a, 102b, and 103c sub-step

### DETAILED DESCRIPTION OF THE EMBODIMENTS

Before the present disclosure is described in detail, it should be noted that similar components are represented by the same reference numbers in the following description.

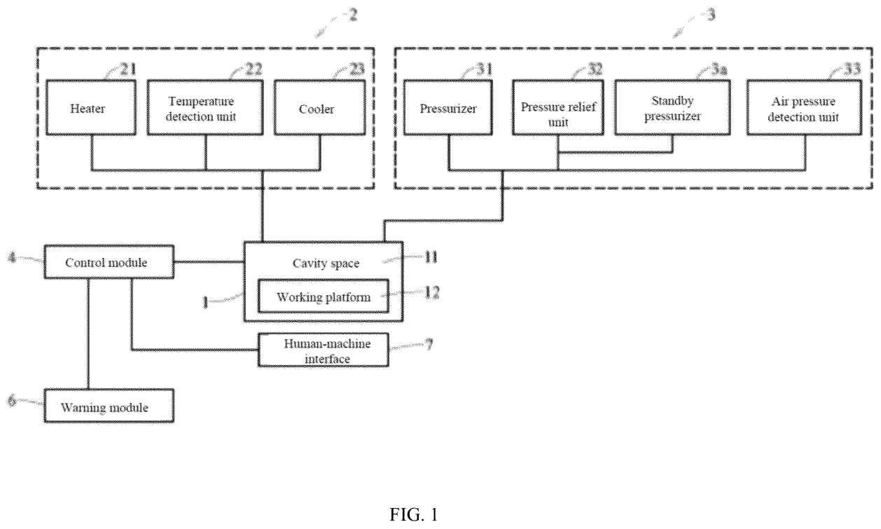

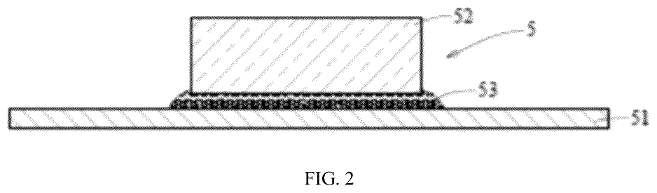

Referring to FIG. 1 and FIG. 2, a foreign object removal apparatus for a packaged electronic component in an embodiment of the present disclosure includes a chamber 1, a temperature module 2, a pressure module 3, a standby pressurizer 3a, a control module 4, a warning module 6, and a human-machine interface 7 connected to the control module 4. The packaged electronic component 5 includes a carrier board 51, a chip 52, and a material layer 53 between the carrier board 51 and the chip 52, where the carrier board 51 may be at least one of a printed circuit board, an organic substrate, a glass substrate, a metal substrate, a lead frame, a wafer, a silicon interposer, and a package. The foreign object removal apparatus is configured to remove a foreign object in the material layer 53. In the following embodiments, the foreign object refers to voids present in the material layer 53. However, in other embodiments, the apparatus may also be configured to remove pollutants such as grease, flux residues, and volatile solvents. Therefore, the foreign object may also refer to the aforementioned pollutants such as the grease, the flux residues, and the volatile solvents. The removal is, for example, removal of the foreign object from the material layer 53 by controlling a temperature and a pressure.

A cavity space 11 is formed in the chamber 1, and a working platform 12 is disposed in the cavity space 11 to place the packaged electronic component 5. The temperature module 2 is disposed in the chamber 1 to detect and control a working temperature in the cavity space 11. The working temperature is, for example, between 25° C. and 800° C. However, the present disclosure is not limited to this. In an embodiment, the working temperature is between the room temperature and 400° C. The temperature module 2 includes a heater 21, a temperature detection unit 22, and a cooler 23. The heater 21 herein may include a heating component and a circuit matched therewith. The heating component may be disposed, for example, in the cavity space 11. The cooler 23 may also include a cooling component and a circuit matched therewith. In an embodiment, the cooler 23 is disposed, for example, outside the chamber 1 and the cavity space 11 and the cooler 23 are connected through a circulating pipeline. Gas from the cavity space 11 is cooled by the cooler 23 and then returns to the cavity space 11. The heater 21 is configured to increase the working temperature in the cavity space 11. The cooler 23 is configured to reduce the working temperature in the cavity space 11. The temperature detection unit 22 is configured to detect the working temperature in the cavity space 11 and transmit the detected working temperature back to the control module 4, thereby providing a basis for whether the control module 4 controls the heater 21 for heating or starts the cooler 23 for cooling.

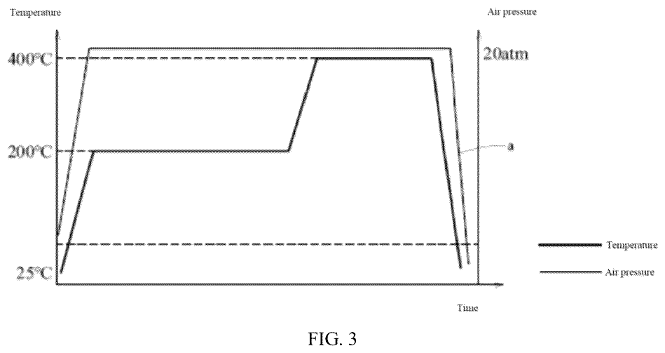

The pressure module 3 is configured to detect and control a working pressure in the cavity space 11, and includes a pressurizer 31 connected to the chamber 1, a pressure relief valve 32 disposed in the chamber 1, and a pressure detection unit 33. The pressurizer 31 herein may include a pressurizing component and a circuit and a pipeline matched therewith. The pressurizing component is, for example, a pressurizing cylinder. In an embodiment, the pressurizer 31 may include two pressurizing components and two pipelines matched with the two pressurizing components respectively. In another embodiment, the pressurizer 31 may include two pressurizing components and a pipeline matched with the two pressurizing components. In yet another embodiment, the pressure module is provided with a plurality of pressurizers 31 connected to the chamber 1. The pressurizer 31 is configured to increase the working pressure in the cavity space 11. The working pressure can reach, for example, 2 atm. The pressure relief valve 32 is configured to relieve the working pressure in the cavity space 11. The pressure detection unit 33 is configured to detect the working pressure in the cavity space 11 and transmit the detected working pressure back to the control module 4, thereby providing a reference for whether the control module 4 adjusts the pressurizer 31 for increasing the pressure or starts the pressure relief valve 32 for pressure relief. The standby pressurizer 3a may be controlled to switch with the pressurizer 31 of the pressure module 3 to operate. The control module 4 is connected to the temperature module 2 and the pressure module 3. The control module 4 may be implemented by, for example, a programmable logic controller (PLC) in conjunction with software, and functions to control the temperature module 2 and the pressure module 3 to operate according to a default temperature-pressure curve (as shown in FIG. 3), so that the working temperature and the working pressure in the cavity space 11 conform to default temperature and pressure in the process of removing the foreign object, thus successfully completing the foreign object removal operation. Moreover, when the working temperature and/or the working pressure are/is abnormal in the process of removing the foreign object, it means that the working temperature or the working pressure deviates from the aforementioned default temperature or pressure to a certain extent. In an embodiment, the anomaly refers to, for example, that the detected working temperature or working pressure exceeds or is below the default temperature or the default pressure by a certain value or above, such as 10% or above, for a certain period of time or above, such as 30 seconds or above. In another embodiment, the anomaly refers to, for example, that the detected working temperature or working pressure exceeds or is below the default temperature or the default pressure by 5% or above for 10 seconds or above. It can be determined whether to continue or start an emergency handling program to reduce the working temperature of the cavity space 11 in a fast cooling mode and control the pressure module 3 to maintain the working pressure of the cavity space 11 within the range of a preset pressure. In an embodiment, the preset pressure may be a certain value not less than a working pressure before cooling, a value that varies with time, or a value pressure that varies with temperature. For example, 150% of the pressure (P₂) that varies with the temperature is not less than [the pressure before cooling (P₁) multiplied by a temperature (T₂) reached by cooling divided by a temperature (T₁) before cooling, i.e., P₁×T₂/T₁]. The temperature herein is in Kelvin (K). Due to the continuous decrease in temperature, the preset pressure will also change accordingly. In other words, to maintain the balance between the temperature and the pressure in the cavity space 11 and the packaged electronic component 5, the ratio of 150% of the pressure (P₂) after cooling to the pressure (P₁) before cooling is not less than the ratio of the temperature (T₂) after cooling to the temperature (T₁) before cooling (i.e., 1.5P₂/P₁≥T₂/T₁). Next, the working pressure of the cavity space 11 is slowly reduced to 1 atm or a pressure by which a chamber door can be opened, so that the packaged electronic component 5 can be transferred to another foreign object removal apparatus or a temporary storage area. In an embodiment, a robotic arm may be used to transfer the packaged electronic component 5 that has not yet completed the foreign object removal operation to another foreign object removal apparatus or the temporary storage area. In another embodiment, manual operation may be performed to transfer the packaged electronic component 5 that has not yet completed the foreign object removal operation to another foreign object removal apparatus or the temporary storage area. However, the present disclosure is not limited to this.

The warning module 6 is connected to the control module 4. Specifically, the warning module may be, for example, a warning signal displayed on the human-machine interface 7 of the foreign object removal apparatus, or a warning device. The warning module is configured to generate a warning when at least one of the working temperature or the working pressure of the cavity space 11 is in an abnormal state, so that an operator may take a corresponding action, such as to start an emergency handling program. The warning device may be, for example, a warning buzzer mounted on the foreign object removal apparatus.

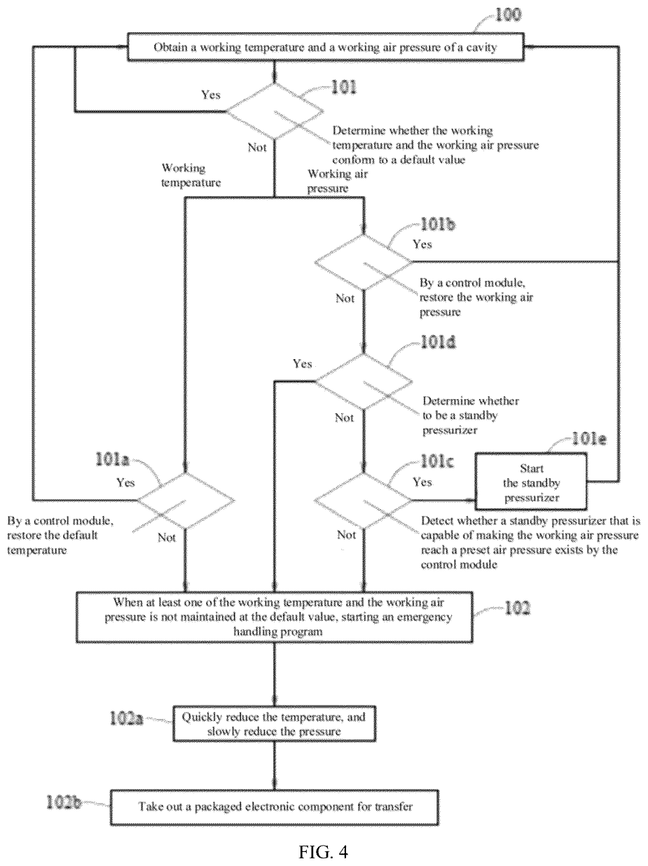

Referring to FIG. 1 and FIG. 4, an anomaly control method of a foreign object removal apparatus for a packaged electronic component in an embodiment of the present disclosure is implemented using the aforementioned foreign object removal apparatus. The method includes the following steps.

In step 100, a working temperature and a working pressure of a cavity space 11 are obtained. In this step, the working temperature and the working pressure in the cavity space 11 are detected by the temperature detection unit 22 and the pressure detection unit 33 respectively and transmitted back to the control module 4, so that the control module 4 receives the working temperature and the working pressure from the temperature detection unit 22 and the pressure detection unit 33 respectively. Herein, the temperature detection unit 22 and the pressure detection unit 33 may be set to regularly detect the working temperature and the working pressure in the cavity space 11 and transmit them back to the control module 4. In an embodiment, the temperature detection unit 22 and the pressure detection unit 33 continuously detect the working temperature and the working pressure in the cavity space 11 and continuously transmit them back to the control module 4. However, the present disclosure is not limited to this.

In step 101, it is determined whether the working temperature and the working pressure conform to a default value. The default values herein refer to the default temperature and the default pressure (corresponding to the default temperature-pressure curve in FIG. 3) that could be met during each period of time in the whole process of removing the foreign object for different packaged electronic components 5 in order to successfully complete the foreign object removal operation. Therefore, in this step, when the control module 4 receives the working temperature and the working pressure from the temperature detection unit 22 and the pressure detection unit 33 during a specific period of time, the working temperature and the working pressure are compared with the default temperature and the default pressure that could be met during the period of time to determine whether the working temperature and the working pressure in the cavity space 11 currently conform to the default temperature and the default pressure. When the obtained working temperature and working pressure conform to the default values, the step 100 and the step 101 are repeated according to the set regular detection.

When at least one of the working temperature and the working pressure does not conform to the default temperature or the default pressure and cannot be controlled to restore to the default value, the control module 4 starts an emergency handling program, namely step 102 to reduce the working temperature and the working pressure until the packaged electronic component 5 can be transferred to another foreign object removal apparatus. Before the step 102 is performed, the following two sub-steps are performed for abnormal working temperature and abnormal working pressure: step 101a, step 101b, and step 101c. The step 101a is mainly performed for the abnormal working temperature, and the step 101b and the step 101c are mainly performed for the abnormal working pressure. In the two sub-steps, the control module 4 may set their order according to actual requirements. For example, it is possible to perform the step 101a first and then perform the step 101b when the working temperature is normal; or to perform the step 101b first and then perform the step 101a when the working pressure is normal; or to perform the steps 101a and 101b synchronously or asynchronously. In the step 101a, when the control module 4 detects that the obtained working temperature does not conform to the default temperature, first, the heater 21 (when the detected working temperature is less than the default temperature) or the cooler 23 (when the detected working temperature is greater than the default temperature) is re-controlled by the control module 4 to act, or the power of the heater 21 or the cooler 23 is increased to restore the working temperature of the cavity space 11 to the default temperature, and if the working temperature still cannot be controlled to restore to the default value, for example, if the working temperature does not conform to the default temperature and still cannot be restored to the default value after a period of time, the aforementioned emergency handling program, namely the step 102 is performed. The step 102 includes sub-steps 102a and 102b. In the sub-step 102a, the temperature is quickly reduced, and the pressure is slowly reduced. In the sub-step 102b, the packaged electronic component 5 is taken out for transfer. Specifically, in the sub-step 102a, first, the cooler 23 is started for quickly reducing the temperature, and the pressure module 3 is controlled to maintain the working pressure of the cavity space 11 above a preset pressure, so that the temperature of the cavity space 11 is reduced to a default temperature, namely a set temperature of the cavity space 11 at which the packaged electronic component 5 can be taken out, such as not greater than 100° C. In an embodiment, the default temperature is not greater than 80° C. In another embodiment, the default temperature is not greater than 40° C. Then, the pressure is slowly reduced, that is, the working pressure of the cavity space 11 is slowly reduced to 1 atm or a pressure by which the chamber door can be opened. Next, the sub-step 102b can be performed to quickly transfer the packaged electronic component 5 that has not yet completed the foreign object removal operation to another foreign object removal apparatus for continuing the foreign object removal operation. In an embodiment, the robotic arm may be used to transfer the packaged electronic component 5 that has not yet completed the foreign object removal operation to another foreign object removal apparatus. In another embodiment, the manual operation may be performed to transfer the packaged electronic component 5 that has not yet completed the foreign object removal operation to another foreign object removal apparatus. However, the present disclosure is not limited to this. It is to be noted that after the aforementioned sub-step 101a, it has been determined that the temperature module 2 is abnormal and cannot continue to operate normally, so that by the step 102, the semi-finished product that has not yet completed the foreign object removal operation is safely and quickly taken out and can be transferred to another machine for continued operation, thereby preventing the unfinished packaged electronic component 5 from continuing to remain in the chamber 1 to be excessively aged and scrapped. Accordingly, the operation of quickly reducing the temperature is required. In addition, during the process of quickly reducing the temperature, in order to avoid the unrestorable damage to the packaged electronic component 5 due to quick changes in temperature and pressure, the temperature still needs to be quickly reduced to maintain the working pressure in the cavity space 11 above a preset pressure, and when the working temperature is reduced to a temperature at which the packaged electronic component 5 is suitable to be taken out, the working pressure is slowly reduced, so that the working pressure is reduced to 1 atm or a pressure by which the chamber door can be opened, that is, the packaged electronic component 5 can be quickly taken out for transfer, as shown in step 102b of FIG. 4. The speed of quickly reducing the temperature may be, for example, 5° C./min or above. In an embodiment, the speed may be 20° C./min or above. In an embodiment, the working pressure of the cavity space 11 is maintained above a preset pressure to quickly reduce the temperature.

The reason for the consideration of slowly reducing the working pressure mentioned above lies in the fact that before the working temperature and the working pressure are abnormal, the cavity space 11 is in a state of high temperature and high pressure. In order to avoid that after the temperature is quickly reduced, the working pressure is reduced too quickly, so that it results in the imbalance of an internal pressure of the packaged electronic component 5, thereby causing the chip 52 to deform. Therefore, after the temperature is quickly reduced, the working pressure of the cavity space 11 is slowly reduced to prevent the chip 52 from deforming due to the imbalance between the internal and external pressures. The specific slow pressure reduction speed may be, for example, 5 Kg/cm² or below per minute, or may be, for example, a speed less than a reduction speed after the foreign object removal apparatus completes the removal of the foreign object in the packaged electronic component 5. For example, in FIG. 3, the pressure reduction speed of a segment marked as a is the reduction speed after normal completion of the removal of the foreign object in the packaged electronic component 5. The aforementioned slow pressure reduction speed may be less than the pressure reduction speed of the segment.

For the handling of the abnormal working pressure in the step 101b and the step 101c, when the received working pressure does not conform to the preset pressure, in the step 101b, the control module 4 is first used to re-control the pressurizer 31 (if the detected working pressure is less than the preset pressure) or the pressure relief valve 32 (if the detected working pressure is greater than the preset pressure) to act for restoring the working pressure in the cavity space 11 to the preset pressure, and if the working pressure still cannot be controlled to restore to the default value, then the step 101c is performed. In the step 101c, the control module 4 detects whether a standby pressurizer 3a exists, and if the standby pressurizer 3a exists, a step 101e is performed to start the standby pressurizer 3a, switch to replace the pressurizer 31 of the pressure module 3 with the standby pressurizer 3a, and repeat the step 100 to detect whether the working pressure conforms to the preset pressure again. In the step 101c, if the standby pressurizer 3a does not exist, or the default pressure still cannot be met even after the standby pressurizer 3a has been switched to replace the pressurizer 31 of the pressure module 3 for operation, then the control module 4 performs the step 102 of the aforementioned emergency handling program to control the working temperature of the cavity space 11 to be quickly reduced and then control the working pressure to be reduced at a slow pressure reduction speed, so that the packaged electronic component 5 can be transferred to another foreign object removal apparatus, as shown in step 102b of FIG. 4. In an embodiment, the control module 4 re-controls the pressurizer 31 of the pressure module 3 to act. The pressurizer 31 may include two pressurizing components and two pipelines matched with the two pressurizing components respectively. In another embodiment, the pressurizer 31 may include two pressurizing components and a pipeline matched with the two pressurizing components. In yet another embodiment, the control module 4 re-controls the pressure module 3 of the foreign object removal apparatus to act. The pressure module is provided with a plurality of pressurizers 31 connected to the chamber.

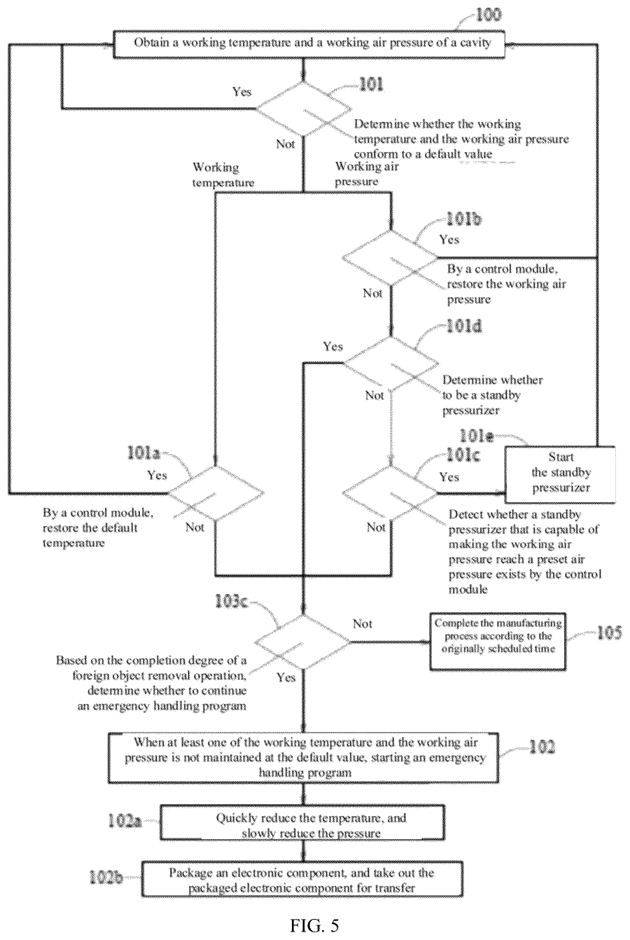

Referring to FIG. 5, in another embodiment, before the step 102, a step 103c may also be performed as needed to determine whether to continue the emergency handling program based on the completion degree of the foreign object removal operation. In this step, when the control module 4 detects that at least one of the obtained working temperature or working pressure does not meet the preset condition, if the progress of the foreign object removal operation has reached a certain period of time, that is, the foreign object removal operation has been mostly completed, then it may not be necessary to start the emergency handling program. Instead, the manufacturing process can be completed according to the originally scheduled time, as shown in step 105 of FIG. 5. In other words, when a time point at which the anomaly occurs is close to the completion of the foreign object removal operation, since the anomaly at this time will no longer affect the result of removing the foreign object in the packaged electronic component 5, it may not be necessary to start the emergency handling program again, and the process can be continued directly according to the program for completing the foreign object removal operation. Herein, the time determination on whether the foreign object removal operation has been mostly completed may be set for the control module 4 according to the physical properties of the material layer 53 from which the foreign object is to be removed. The determination may be performed based on the operation time. For example, in an embodiment, if the foreign object removal operation has been carried out for 60% or above of the scheduled time, the emergency handling program will not start, and the process is continued directly according to the program for completing the foreign object removal operation.

In the aforementioned FIG. 4 and FIG. 5, for the step 101c, in an embodiment where the standby pressurizer 3a is provided for switching, before the step 101c is performed, the control module 4 may also first perform a step 101d to determine whether the current source of providing the pressure is already the standby pressurizer 3a, and if the current source of providing the pressure is the standby pressurizer 3a, the step 101c is omitted in the case where there are no other switchable additional pressurizers 3a, otherwise, the step 101c is continued.

In addition, in another case, the factors that cause at least one of the working temperature and the working pressure not to conform to the default temperature or the default pressure and thus require the control module 4 to start the emergency handling program in the step 102 may also be caused by temporary power outage or power failure. At this time, before the step 102 is performed, an uninterruptible power supply system (or a backup power supply) may also be used first to preferentially drive the temperature module 2 or the pressure module 3 to act. Then, the emergency handling program is executed to carry out quick cooling and subsequent slow pressure reduction, so that the packaged electronic component 5 can be taken out, thereby preventing the unfinished packaged electronic component 5 from continuing to remain in the chamber 1 to be excessively aged and scrapped.

In addition, it is to be noted that when the set working temperature and working pressure are compared with the default temperature and the default pressure, a positive and negative tolerance range may be allowed for the default temperature and the default pressure according to the actual usage situation. As long as the positive and negative tolerance range is not exceeded, both the working temperature and the working pressure may be regarded as the same as the default temperature and the default pressure.

In summary, according to the foreign object removal apparatus and the anomaly control method thereof, when the packaged electronic component 5 is abnormal in the process of removing the foreign object, the abnormal situation can be quickly eliminated in the most effective way, and when it is confirmed that the abnormal situation cannot be eliminated, the temperature can be quickly reduced, the pressure can be slowly reduced, and the packaged electronic component 5 that has not yet completed the foreign object removal operation is taken out, so that the packaged electronic component can be transferred to another foreign object removal apparatus for continued operation, thereby avoiding the damage and scrap of the packaged electronic component 5 due to the anomaly of a device, and effectively reducing the cost loss caused by the defect rate. Therefore, the objectives of the present disclosure can be indeed achieved.

The above descriptions are only embodiments of the present disclosure and cannot limit the scope of implementation of the present disclosure. Any simple equivalent changes and modifications made in accordance with the scope of the patent application and the content of the patent specification of the present disclosure still fall within the scope of the patent of the present disclosure.

What is claimed is:

1. A foreign object removal apparatus for a packaged electronic component, configured to remove a foreign object in the packaged electronic component, and comprising:
a chamber formed with a cavity space;
a temperature module disposed in the chamber and comprising a heater configured to increase a working temperature in the cavity space, a cooler configured to reduce the working temperature in the cavity space, and a temperature detection unit configured to detect the working temperature in the cavity space;
an pressure module disposed in the chamber and comprising a pressurizer configured to increase a working pressure in the cavity space, a pressure relief valve configured to reduce the working pressure in the cavity space, and an pressure detection unit configured to detect the working pressure in the cavity space; and
a control module connected to the temperature module and the pressure module, and configured to start, when at least one of the working temperature and the working pressure of the cavity space is in an abnormal state, an emergency handling program to reduce the working temperature of the cavity space in a fast cooling mode and control the pressure module to maintain the working pressure of the cavity space above a preset pressure and then slowly reduce the working pressure of the cavity space after the working temperature of the cavity space is reduced to a set temperature of the cavity space.

2. The foreign object removal apparatus according to claim 1, further comprising a standby pressurizer, wherein the control module is also capable of switching to provide the working pressure by the standby pressurizer when the pressure detection unit detects that the working pressure of the cavity space is in the abnormal state.

3. The foreign object removal apparatus according to claim 1, further comprising a warning module that is connected to the control module and gives a warning when at least one of the working temperature or the working pressure of the cavity space is in the abnormal state.

4. The foreign object removal apparatus according to claim 1, further comprising a human-machine interface connected to the control module, wherein an input is provided to set default values for the working temperature and the working pressure.

5. The foreign object removal apparatus according to claim 3, further comprising a human-machine interface connected to the control module, wherein an input is provided to set default values for the working temperature and the working pressure.

6. The foreign object removal apparatus according to claim 1, wherein the pressurizer comprises two pressurizing components and at least one pipeline matched with the two pressurizing components.

7. An anomaly control method for a foreign object removal apparatus, the foreign object removal apparatus being configured to remove a foreign object in a packaged electronic component, the foreign object removal apparatus comprising a cavity space and a control module configured to control a working temperature and a working pressure of the cavity space, and the anomaly control method comprising:
obtaining the working temperature and the working pressure of the cavity space;
determining whether the working temperature and the working pressure conform to a default value by the control module; and
when at least one of the working temperature and the working pressure does not conform to the default value, starting an emergency handling program by the control module to first quickly reduce the working temperature to a predetermined temperature, maintain the working pressure of the cavity space above a preset pressure, and slowly reduce the working pressure of the cavity space.

8. The anomaly control method according to claim 7, wherein the control module starts the emergency handling program to control the working temperature of the cavity space to be quickly reduced at a speed of 5° C./min or above.

9. The anomaly control method according to claim 7, wherein when the working temperature does not conform to the default value, before starting the emergency handling program, the control module re-controls a temperature module of the foreign object removal apparatus to act for restoring the working temperature of the cavity space to the default value, and if the working temperature of the cavity space is incapable of being restored, the working temperature of the cavity space is controlled to be quickly reduced to be in a state where the packaged electronic component is capable of being moved out of the chamber.

10. The anomaly control method according to claim 7, wherein when the working pressure does not conform to the default value, before starting the emergency handling program, the control module re-controls an pressure module of the foreign object removal apparatus to act for restoring the working pressure of the cavity space to the default value, and if the working pressure of the chamber is incapable of being restored, the control module starts the emergency handling program.

11. The anomaly control method according to claim 7, wherein when the working pressure does not conform to the default value, before starting the emergency handling program, the control module detects whether a standby pressurizer that is capable of making the working pressure conform to the default value exists, and if the standby pressurizer exists, switching is performed to make the standby pressurizer replace a pressurizer of the foreign object removal apparatus to operate for making the working pressure conform to the default value.

12. The anomaly control method according to claim 11, wherein when the control module detects that the standby pressurizer that is capable of making the working pressure conform to the default value does not exist, or the standby pressurizer is incapable of making the working pressure conform to the default value, the control module starts the emergency handling program to control the working temperature of the cavity space to be quickly reduced to a predetermined temperature, maintain the working pressure of the cavity space above a preset pressure, and slowly reduce the working pressure of the cavity space to ensure that the packaged electronic component is capable of being transferred to another foreign object removal apparatus.

13. The anomaly control method according to claim 7, wherein in the emergency handling program, the control module controls the working temperature to be quickly reduced and then slowly reduces the working pressure of the cavity space, and controls the slowly reduced working pressure to be slowly reduced at a speed of 5 Kg/cm² or below per minute.

14. The anomaly control method according to claim 10, wherein in the emergency handling program, the control module controls the working temperature to be quickly reduced and then slowly reduces the working pressure of the cavity space, and controls the slowly reduced working pressure to be slowly reduced at a speed of 5 Kg/cm² or below per minute.

15. The anomaly control method according to claim 12, wherein in the emergency handling program, the control module controls the working temperature to be quickly reduced and then slowly reduces the working pressure of the cavity space, and controls the slowly reduced working pressure to be slowly reduced at a speed of 5 Kg/cm² or below per minute.

16. The anomaly control method according to claim 7, wherein the working temperature of the cavity space is controlled to be quickly reduced to a predetermined temperature of not greater than 100° C.

17. The anomaly control method according to claim 10, wherein the working temperature of the cavity space is controlled to be quickly reduced to a predetermined temperature of not greater than 100° C.

18. The anomaly control method according to claim 12, wherein the working temperature of the cavity space is controlled to be quickly reduced to a predetermined temperature of not greater than 100° C.

19. The anomaly control method according to claim 7, wherein in the emergency handling program, the control module controls the working temperature to be quickly reduced and then controls the working pressure to be reduced at a speed less than a reduction speed after the foreign object removal apparatus completes the removal of the foreign object in the packaged electronic component.

20. The anomaly control method according to claim 10, wherein in the emergency handling program, the control module controls the working temperature to be quickly reduced and then controls the working pressure to be reduced at a speed less than a reduction speed after the foreign object removal apparatus completes the removal of the foreign object in the packaged electronic component.

21. The anomaly control method according to claim 12, wherein in the emergency handling program, the control module controls the working temperature to be quickly reduced and then controls the working pressure to be reduced at a speed less than a reduction speed after the foreign object removal apparatus completes the removal of the foreign object in the packaged electronic component.

22. The anomaly control method according to claim 7, wherein in the emergency handling program, 150% of the default pressure is not less than the ratio of an pressure before cooling multiplied by a temperature reached by cooling to a temperature before cooling.

23. The anomaly control method according to claim 10, wherein the pressure module is provided with a plurality of pressurizers connected to the cavity space.
